(19) United States
(12) Patent Application Publication
(10) Pub. No.: US 2003/0114116 A1
(43) Pub. Date: Jun. 19, 2003

(54) Rear entertainment system

(75) Inventors: Takao Inoue, Saitama (JP); Satoshi Kaminaga, Saitama (JP)

Correspondence Address: MORGAN LEWIS & BOCKIUS LLP, 1111 PENNSYLVANIA AVENUE NW, WASHINGTON, DC, 20004, US

(73) Assignee: Pioneer Corporation

(21) Appl. No.: 10/298,943

(22) Filed: Nov. 19, 2002

(30) Foreign Application Priority Data
Nov. 28, 2001 (JP) P. 2001-363120

(51) Int. Cl. H04B 1/38

(52) U.S. Cl. 455/73

(57) ABSTRACT

A first IR transmission portion is disposed in front of a rear seat of a vehicle while a second IR transmission portion is disposed at the rear of the rear seat. A fellow passenger in the rear seat puts on headphones so as to receive and listen to audio signals. The first and second IR transmission portions optically modulate the same audio information and radiate it spatially. For example, LEDs emitting infrared light are used as devices for the optical conversion. The first IR transmission portion transmits optical signals from the front toward the rear while the second IR transmission portion transmits the optical signals from the rear toward the front. Particularly by the second IR transmission portion, the signals are transmitted to the front including the driver's seat of the vehicle so that any dead zone can be removed from the vehicle interior.

The present disclosure relates to the subject matter contained in Japanese Patent Application No. 2001-363120 filed on Nov. 28, 2001, which is incorporated herein by reference in its entirety.

### BACKGROUND OF THE INVENTION

1. Field of the Invention

The present invention relates to a rear entertainment system enabling a fellow passenger in a rear seat to be entertained with video or music in a movable body such as a vehicle, and particularly relates to a technical field of a rear entertainment system capable of optical transmission of signals without being affected by external light such as sunlight.

2. Description of the Related Art

In the related art, such a rear entertainment system is disposed independently of a navigation screen disposed at a driver's seat or a front seat, and designed so that movies or news can be watched or listened to in a rear seat through a rear seat monitor unit. Particularly audio is generally listened to with headphones so as not to be disturbed by noise including the driving noise of the vehicle or music for the front seat.

In addition, audio signals are transmitted from the rear seat monitor unit to the headphones by a wireless unit using infrared light. The rear seat monitor unit has a unit for modulating audio signals and transmitting the modulated audio signals as optical signals. On the other hand, the headphones have a unit for receiving the optical signals and demodulating the optical signals to thereby convert them into audio signals as an audio output.

In the related-art configuration, however, the transmitting unit is provided at one front place on the side of the rear seat monitor unit, while the headphones have only light receiving devices having directivity to the front for receiving optical signals from the front. Therefore, when disturbing light such as sunlight from the front enters the headphones, the light receiving devices of the headphones are affected by the light so that it is difficult or impossible for the light receiving devices to receive the optical signals correctly.

As measures to cope with this problem, there has been hitherto adopted a method in which a visible light cutting characteristic is provided to the light receiving devices, and an optical filter is further used to cut the disturbing light optically. In this method, the quantity of the disturbing light causing a malfunction has to be grasped in advance. Thus, in consideration of the directivity of the infrared LEDs on the transmitting side, the propagation distance, and the directivity on the receiving side, the optical filter for cutting the disturbing light is set not to cause a malfunction. Further, the transmitting output has to be increased to cover the attenuation of the quantity of transmitted light caused by the insertion of the optical filter.

In addition, when the fellow passenger in the rear seat changes his or her position, or turns his or her head, there is a fear that reception or demodulation of optical signals is not performed sufficiently correctly.

### SUMMARY OF THE INVENTION

Accordingly, the invention is developed taking the foregoing problems into consideration. It is an object of the invention to provide a rear entertainment system in which even if intensive disturbing light is incident from any direction, there is little fear that the disturbing light interferes with the reception or demodulation of optical signals, and the optical signals can be received and demodulated no matter where a fellow passenger in the rear seat is or no matter how the fellow passenger turns his or her head.

In order to solve the problems, the rear entertainment system according to the invention is a rear entertainment system mounted on a rear seat of a vehicle, the system having an audio signal transmitting unit and an audio signal receiving unit. The audio signal transmitting unit includes a signal supply unit for supplying same audio signals to the first and second transmitting units, a first transmitting unit disposed in front of the rear seat and for transmitting the supplied audio signals backward, and a second transmitting unit disposed at a rear of the rear seat and for transmitting the supplied audio signals forward. The audio signal receiving unit includes a first receiving unit for receiving audio signals transmitted backward by at least one of the first and second transmitting units, a second receiving unit for receiving audio signals transmitted forward by at least one of the first and second transmitting units, and an audio signal converting unit capable of abutting against left and right ears and for converting the audio signals received by at least one of the first and second receiving units into sound based on mechanical vibration.

According to the rear entertainment system of the invention, in the audio signal transmitting unit, transmitting units for transmitting audio information are provided in a predetermined position in front of the rear seat of the vehicle and in a predetermined position at the rear of the rear seat. The front-side transmitting unit transmits audio signals backward while the rear-side transmitting unit transmits the audio signals forward. The rear-side transmitting unit covers all the front side of the vehicle beyond the area of the rear seat as its signal transmission area. In addition, a unit for supplying the same audio information to the respective transmitting units is provided. Incidentally, “forward” or “backward” in connection with transmission or reception in the invention has an angle range varying in dependence on the directivity of the transmitting unit or the receiving unit. Thus, “forward” or “backward” provides no specific limitation on the angle range. That is, for example, “forward” may mean a wide range excluding “right behind”, while “backward” may mean a wide range excluding “right front”. The specific angle ranges corresponding to these words “forward” and “backward” vary individually and specifically in accordance with the specifications of the system in themselves.

On the other hand, the audio signal receiving unit has a receiving unit for receiving the audio signals from the transmitting unit disposed in the front and a receiving unit for receiving the audio signals from the transmitting unit disposed at the rear, as units for receiving the audio signals from the transmitting units. In addition, the audio signal receiving unit has a conversion unit for converting the audio signals into audio based on mechanical vibration. The conversion unit is designed to be able to abut against the ear portions of a fellow passenger in the rear seat.

With the configuration described above, the fellow passenger in the rear seat can receive and listen to the audio signals sent from the front or the rear.

In a configuration of the rear entertainment system according to the invention, each of the first and second transmitting units has a unit for optically modulating audio signals and radiating the optically modulated audio signals.

With this configuration, the fellow passenger in the rear seat can receive and listen to the light into which the audio signals sent from the front or the rear are modulated. Thus, a cordless system can be materialized.

In another configuration of the rear entertainment system according to the invention, light emitting devices used for the optical modulation are LEDs (Light Emitting Diode).

With this configuration, LEDs are used as the light emitting devices for modulating the audio signals into optical signals and radiating the modulated optical signals. The LEDs are suitably used for optical modulation because they have low voltage, low power consumption and excellent frequency response.

In a further configuration of the rear entertainment system according to the invention, optical wavelength used for the optical modulation is in an infrared region.

With this configuration, optical wavelength in an infrared region is used. Thus, the system is isolated from disturbance caused by visible light.

In a still further configuration of the rear entertainment system according to the invention, the signal supply unit and the first transmitting unit are formed integrally with a rear monitor unit.

With this configuration, the signal supply unit and the transmitting unit provided in front and for transmitting audio signals are formed integrally with a monitor disposed at the rear seat and for displaying video images of contents information. Accordingly, the unit becomes compact as a whole. In addition, external wiring is not required so that the system becomes preferable in terms of the beauty in the interior of the vehicle.

In another configuration of the rear entertainment system according to the invention, the first receiving unit has light receiving devices for receiving modulated light radiated backward, the light receiving devices being located near left and right ears respectively, and the second receiving unit has light receiving devices for receiving modulated light radiated forward, the light receiving devices being located near left and right ears respectively.

With this configuration, the audio signals coming from the front and the audio signals coming from the rear can be received in the positions of the ears of the fellow passenger in the rear seat. Since the light receiving devices are provided in the positions of the left and right ear portions respectively, reception can be achieved even if one of the ears is hidden. In addition, reception can be achieved surely even if the fellow passenger moves his or her head desirably.

In a further configuration of the rear entertainment system according to the invention, the light receiving devices are photodiodes.

With this configuration, photodiodes are used as the light receiving devices constituting the receiving units. The photodiodes are used suitably for a cordless system because they have low voltage, low power consumption and excellent frequency response.

In a still further configuration of the rear entertainment system according to the invention, the light receiving devices are phototransistors.

With this configuration, phototransistors are used as the light receiving devices constituting the receiving units. The phototransistors are used suitably for a cordless system because they have low voltage, low power consumption and excellent frequency response.

In another configuration of the rear entertainment system according to the invention, each of cathode terminals of the photodiodes is connected to a power supply side through a reverse bias resistor individually, while anode terminals thereof are connected to an output transistor in common.

With this configuration, each of cathode terminals of the photodiodes is connected to a power supply through a reverse bias resistor individually. Accordingly, reception signals can be output with reduced influence of the light receiving conditions of the other photodiodes. That is, audio signals can be received and reproduced if any one of the photodiodes is not exposed to disturbing light.

In a further configuration of the rear entertainment system according to the invention, each of cathode terminals of the photodiodes is connected to a power supply side through a current limiter unit individually, while anode terminals thereof are connected to an output transistor in common.

With this configuration, each of cathode terminals of the photodiodes is connected to a power supply through a current limiter unit individually. Accordingly, reception signals can be output with reduced influence of the light receiving conditions of the other photodiodes. That is, audio signals can be received and reproduced if any one of the photodiodes is not exposed to disturbing light.

In a still further configuration of the rear entertainment system according to the invention, each of cathode terminals of the photodiodes is connected to a power supply side through a current breaker unit individually, while anode terminals thereof are connected to an output transistor in common.

With this configuration, each of cathode terminals of the photodiodes is connected to a power supply through a current breaker unit individually. Accordingly, reception signals can be output with extremely reduced influence of the light receiving conditions of the other photodiodes. That is, audio signals can be received and reproduced with higher quality if any one of the photodiodes is not exposed to disturbing light.

In another configuration of the rear entertainment system according to the invention, each of cathode terminals of the photodiodes is connected to a power supply side through a current breaker unit and a current limiter unit in series individually, while anode terminals thereof are connected to an output transistor in common.

With this configuration, each of cathode terminals of the photodiodes is connected to a power supply through a current breaker unit and a current limiter unit individually. Accordingly, reception signals can be output with reduced influence of the light receiving conditions of the other photodiodes. That is, audio signals can be received and reproduced with extremely high quality if any one of the photodiodes is not exposed to disturbing light.

In a further configuration of the rear entertainment system according to the invention, the anode terminals of the photodiodes connected in common are grounded through an inductor.

With this configuration, anode terminals of the photodiodes are grounded through an inductor in common so that a voltage corresponding to an optical signal modulated in a high frequency is generated in the anode terminals. The voltage is supplied to an output transistor from the anode terminals, guided into a processing circuit in a subsequent stage, and extracted as an audio signal.

In a still further configuration of the rear entertainment system according to the invention, the first and second receiving units and the audio signal converting unit constitute headphones.

With this configuration, the receiving units and the audio signal converting unit for converting audio signals into mechanical sound are formed as headphones. When the fellow passenger in the rear seat puts on the headphones which can be made cordless, the fellow passenger can listen to the audio signals. In addition, the fellow passenger can listen to the audio signals without a pause even if the fellow passenger moves in the vehicle interior or turns his or her head.

The operations and other gains of the invention will be made obvious in the following “DETAILED DESCRIPTION OF THE PREFERRED EMBODIMENTS”.

### BRIEF DESCRIPTION OF THE DRAWINGS

FIG. 1 is a view showing the state where a rear entertainment system according to the invention has been applied to a vehicle.

FIG. 2 is a view showing the configuration of the rear entertainment system according to the invention.

FIG. 3 is a diagram showing the configuration of the transmitting side of the rear entertainment system according to the invention.

FIG. 4 is a diagram showing the configuration of an optical reception portion of a rear entertainment system according a first embodiment of the invention.

FIG. 5 is a diagram showing the configuration of the receiving side of the rear entertainment system according to the invention.

FIG. 6 is a view for explaining the effect of the rear entertainment system according to the invention.

FIG. 7 is a graph showing the output of received light in accordance with the presence/absence of disturbing light in the first embodiment.

FIG. 8 is a circuit diagram in which a reverse bias resistor is used in common in an optical reception portion of a rear entertainment system.

FIG. 9 is a graph showing the output of received light in accordance with the presence/absence of disturbing light when the reverse bias resistor is used in common in the optical reception portion of the rear entertainment system.

FIG. 10 is a diagram showing the configuration of an optical reception portion of a rear entertainment system according a second embodiment of the invention.

FIG. 11 is a diagram showing the circuit configuration of the optical reception portion according to the second embodiment.

FIG. 12 is a graph showing the output of received light in accordance with the presence/absence of disturbing light in the second embodiment.

FIG. 13 is a diagram showing the configuration of an optical reception portion of a rear entertainment system according a third embodiment of the invention.

FIG. 14 is a diagram showing the circuit configuration of the optical reception portion according to the third embodiment.

### DETAILED DESCRIPTION OF THE PREFERRED EMBODIMENTS

Embodiments of the invention will be described below with reference to the drawings.

(First Embodiment)

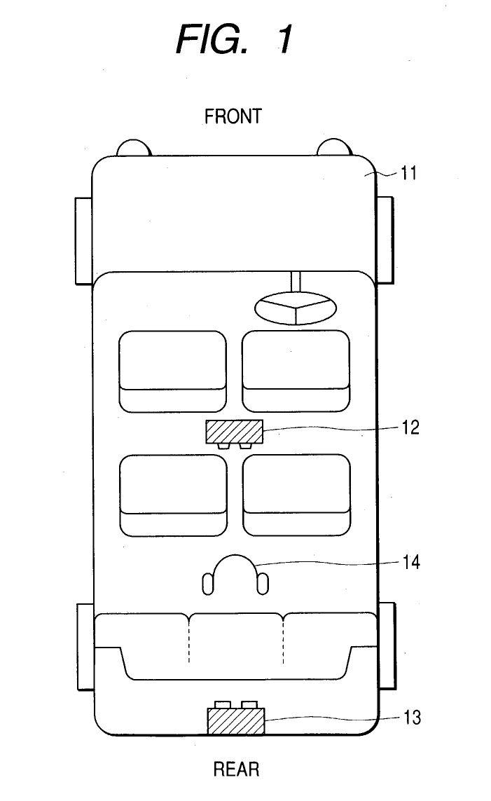

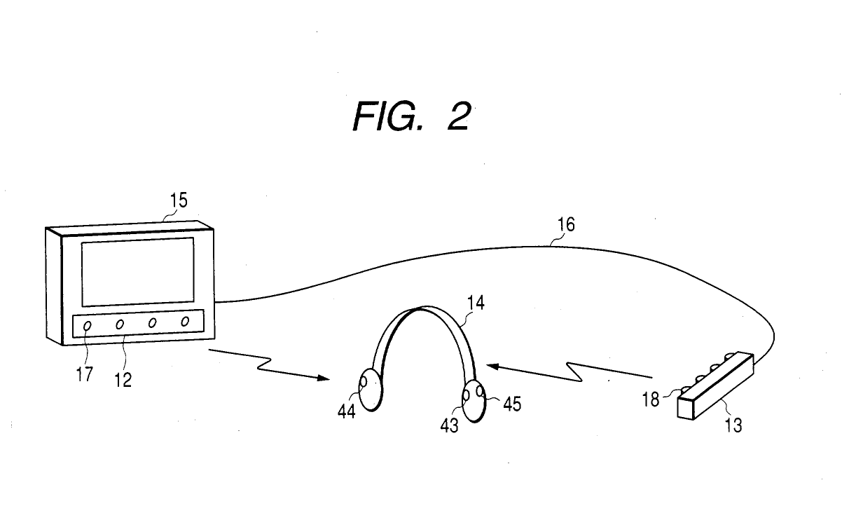

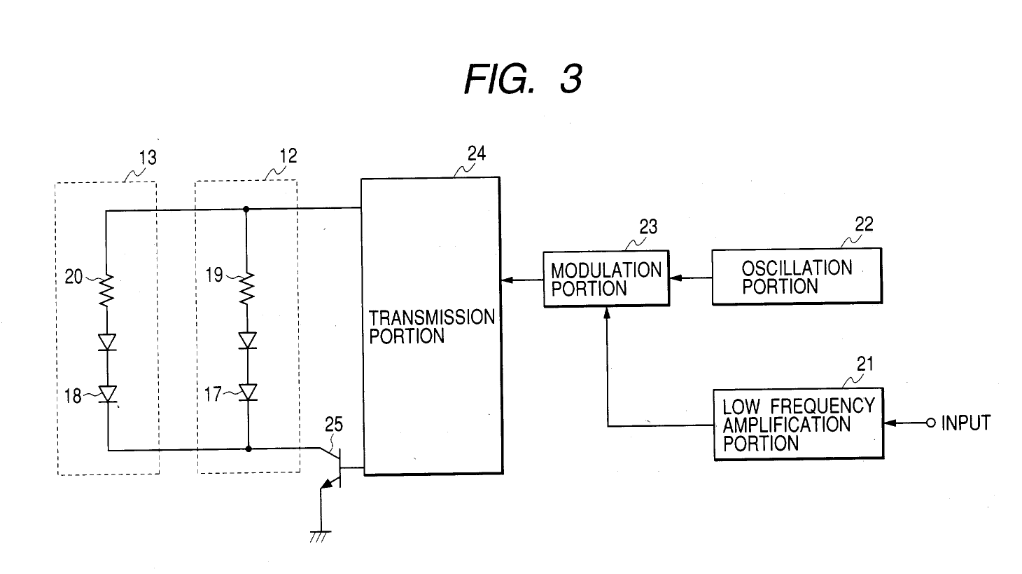

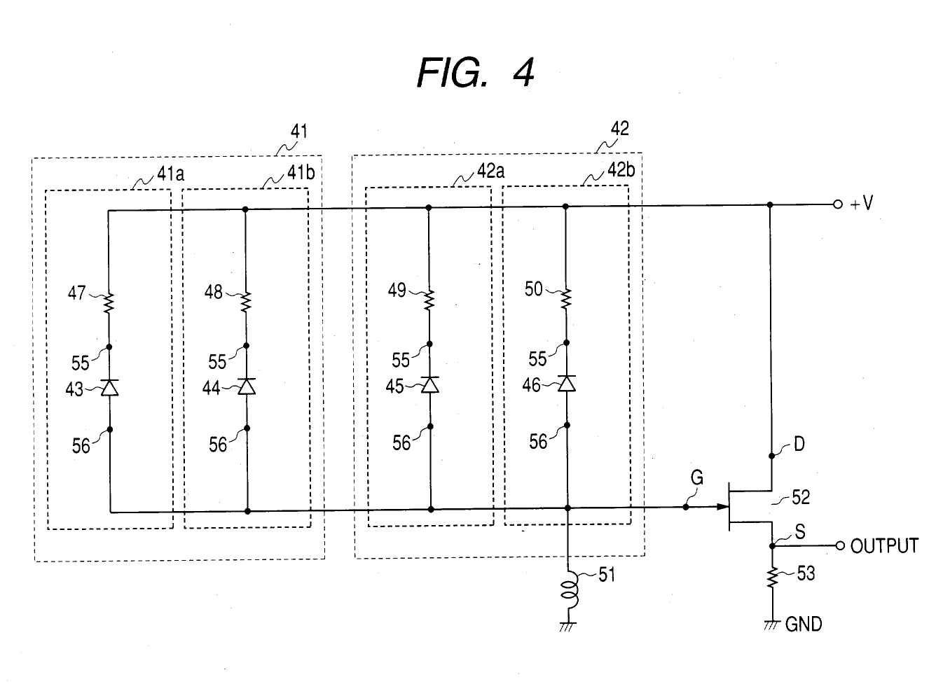

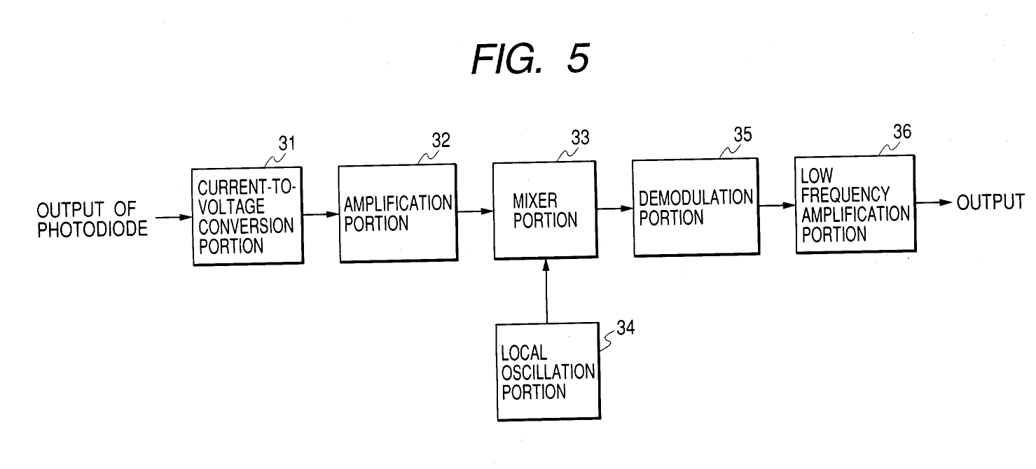

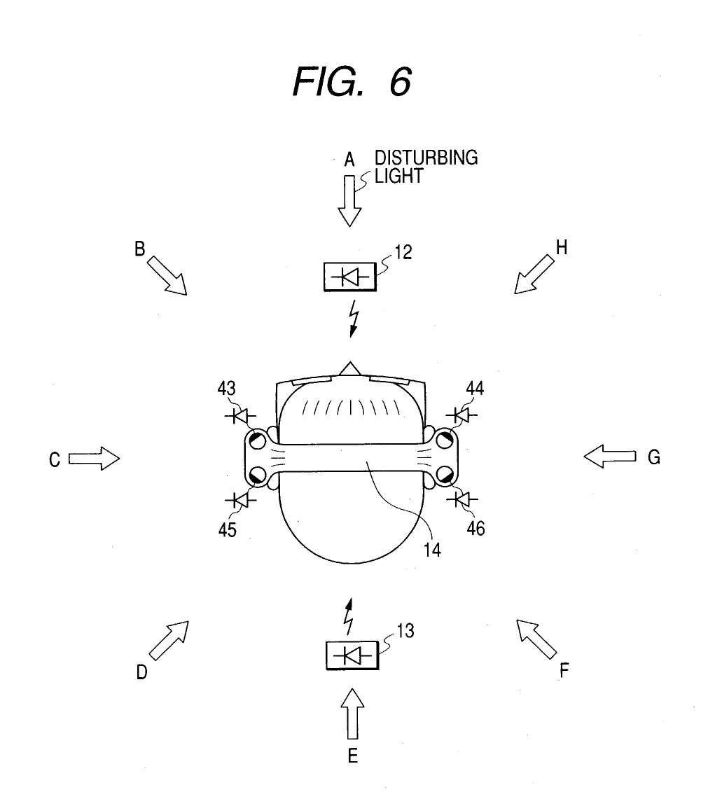

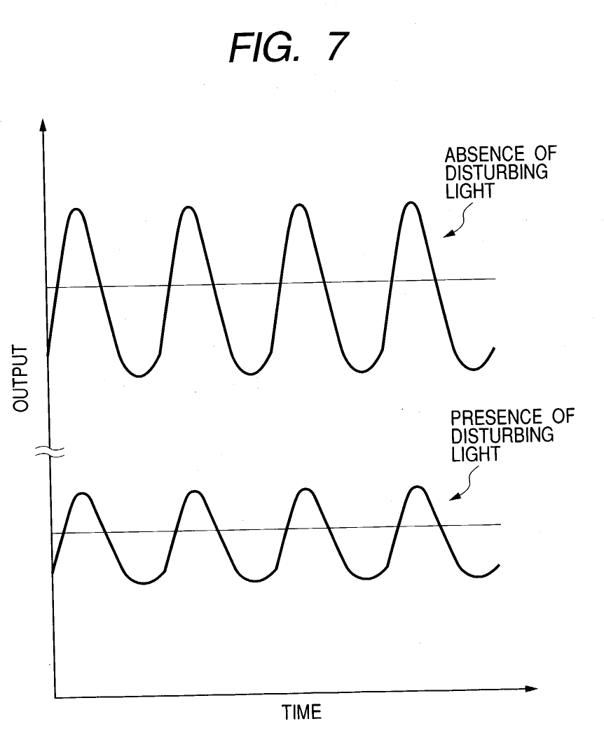

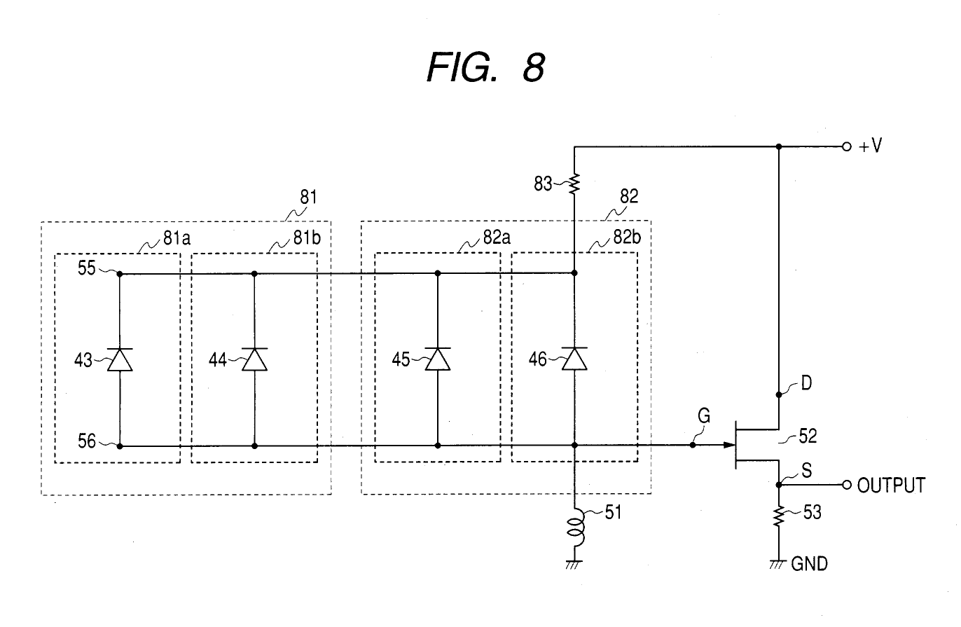

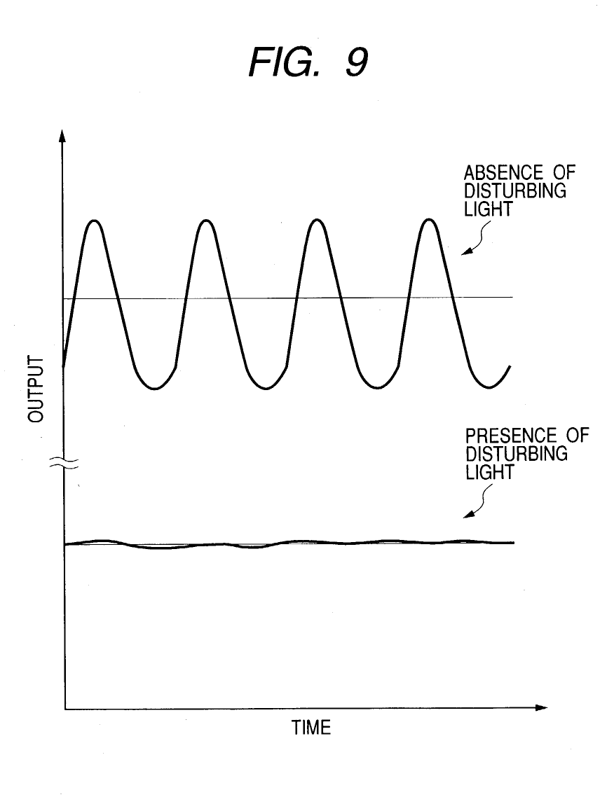

First, the first embodiment will be described with reference to FIGS. 1 to 9. Here, FIG. 1 is a view showing the state in which a rear entertainment system according to the invention has been applied to a vehicle. FIG. 2 is a view showing the configuration of the rear entertainment system according to the invention. FIG. 3 is a diagram showing the configuration of a transmitting side of the rear entertainment system according to the invention. FIG. 4 is a diagram showing the configuration of an optical reception portion in the rear entertainment system according to the first embodiment of the invention. FIG. 5 is a diagram showing the configuration of a receiving side of the rear entertainment system according to the invention. FIG. 6 is a view for explaining the effect of the rear entertainment system according to the invention. FIG. 7 is a graph showing the variation of an output of received light in accordance with the presence/absence of disturbing light in the first embodiment. FIG. 8 is a circuit diagram using a reverse bias resistor in common in the optical reception portion in the rear entertainment system. FIG. 9 is a graph showing the variation of an output of received light in accordance with the presence/absence of disturbing light when the reverse bias resistor is used in common in the optical reception portion.

In the rear entertainment system according to the invention mounted in a vehicle 11 as shown in FIG. 1, a first IR (InfRared) transmission portion 12 is disposed in front of a rear seat, and a second IR transmission portion 13 is disposed at the rear of the rear seat. A fellow passenger in the rear seat puts on headphones 14 so as to receive and listen to audio signals.

The first and second IR transmission portions 12 and 13 optically modulate the same audio information and radiate the optically modulated audio information spatially. For example, LEDs emitting infrared light are used as devices for converting the audio information. The first IR transmission portion 12 transmits audio signals from the front toward the rear while the second IR transmission portion 13 transmits the same audio signals from the rear toward the front. Particularly by the second IR transmission portion 13, the signals are transmitted to the front including the driver's seat of the vehicle 11 so that any dead zone can be removed from the vehicle.

As shown in FIG. 2, in the configuration of the rear entertainment system according to the invention, the first IR transmission portion 12 disposed in front is arranged integrally with a rear monitor 15 for displaying navigation information or contents information. LEDs 17 for radiating modulated light are provided at predetermined places in the front face of the rear monitor 15. A unit for modulating audio information and driving the LEDs 17 are also provided in the rear monitor 15, and formed integrally therewith.

On the other hand, the second IR transmission portion 13 disposed at the rear is connected through a cable 16 to the unit provided in the rear monitor 15 and for modulating audio information. The second IR transmission portion 13 drives LEDs 18. The LEDs 17 and the LEDs 18 are devices for radiating infrared light, and they have, for example, an angle of radiation of 45 degrees. Faint radio waves maybe used instead of the cable 16. In this case, vehicle-interior wiring becomes dispensable, but a circuit and an antenna for transmitting the radio waves are required. Further, when the radio waves are used, phase matching with the output transmitted forward has to be carried out in the subsequent processing. Accordingly, using the cable 16 is more advantageous than using the radio waves from the point of view of no need for such additional parts and processing.

The headphones 14 are used for the fellow passenger in the rear seat to put them on to receive and listen to audio signals. Photodiodes 43, 44 and 45 and a not-shown photodiode 46 disposed in a position pairing with the photodiode 44 are provided as light receiving devices in the headphones 14. The photodiodes 43 and 45 are provided in the right earmuff portion while the photodiodes 44 and 46 are provided in the left earmuff portion. The photodiodes 43 and 44 are arranged to receive optical signals sent backward by the first IR transmission portion 12 while the photodiodes 45 and 46 are arranged to receive optical signals sent forward by the second IR transmission portion 13.

As described previously, the rear entertainment system according to the invention has a feature as follows. That is, a transmission portion for radiating modulated infrared light backward is disposed in front of the rear seat while a transmission portion for radiating the modulated infrared light forward is disposed at the rear of the rear seat. Further, light receiving devices for receiving optical signals from the front and from the rear are provided in the left and right ear portions of the headphones as reception units.

Next, as shown in the block diagram of FIG. 3, the transmitting side is constituted by a low frequency amplification portion 21, an oscillation portion 22, a modulation portion 23, a transmission portion 24, a first IR transmission portion 12 having a resistor 19 and LEDs 17, a second IR transmission portion 13 having a resistor 20 and LEDs 18, and a transistor 25.

Audio information is supplied to the low frequency amplification portion 21 so as to be amplified to a predetermined level. The amplified audio information is then supplied to the modulation portion 23. A frequency oscillation signal to be used for modulation is generated in the oscillation portion 22. This oscillation signal is also supplied to the modulation portion 23 so that the audio information is modulated into a form suitable for optical transmission. The modulated audio information is supplied to the transmission portion 24. The transistor 25 is controlled to drive the first IR transmission portion 12 disposed in front and the second IR transmission portion 13 disposed at the rear. Thus, signals in accordance with the supplied audio information are optically modulated and radiated from the LEDs 17 and 18 to the space, for example, to the vehicle interior when the rear entertainment system is disposed in a vehicle.

Next, as shown in FIG. 4, the reception portion is constituted as follows. That is, cathode terminals 55 of photodiodes 43, 44, 45 and 46 to be used by reverse bias are connected to a power supply +V through reverse bias resistors 47, 48, 49 and 50 respectively. On the other hand, anode terminals 56 are connected in common and grounded through an inductor 51. Signals detected in the photodiodes 43, 44, 45 and 46 are high frequency waves. A detection signal appears at the connection terminal between the inductor 51 and the anode terminals 56.

On the other hand, the anode terminals 56 are connected to the gate G of an FET (Field Effect Transistor) 52. The drain D of the FET 52 is connected to the power supply +V while the source S thereof is grounded through a resistor 53. An output of received light is extracted from the source S of the FET. A bipolar transistor may be used instead of the FET 52. However, when high speed performance as high as the bipolar transistor is not required, it is preferable to use an FET suitable for converting a faint current output into a voltage.

In FIG. 4, the reference numeral 41 represents a portion for receiving modulated light from the front. Further, in the portion 41, the reference numeral 41a represents a part provided in the right ear portion of the headphones 14, and the reference numeral 41b represents a part provided in the left ear portion of the headphones 14. On the other hand, the reference numeral 42 represents a portion for receiving modulated light from the rear likewise. Further, in the portion 42, the reference numeral 42a represents a part provided in the right ear portion of the headphones 14, and the reference numeral 42b represents a part provided in the left ear portion of the headphones 14.

Next, as shown in the circuit block diagram of FIG. 5, the reception-side signal processing circuit is constituted by a current-to-voltage conversion portion 31, an amplification portion 32, a mixer portion 33, a local oscillation portion 34, a demodulation portion 35, and a low frequency amplification portion 36.

An output current from the photodiodes 43, 44, 45 and 46 shown in FIG. 4 is supplied to the current-to-voltage conversion portion 31 constituted by the FET 52 or the like. Thus, the output current is converted into a voltage. The voltage-converted signal is amplified to a predetermined level by the amplification portion 32, and supplied to the mixer portion 33. The amplified signal is synthesized by the mixer portion 33 with a signal oscillated at a predetermined frequency by the local oscillation portion 34, and supplied to the demodulation portion 35 in the next stage. Thus, the transmitted signal is demodulated. Next, an audio signal component is amplified by the low frequency amplification portion 36 and supplied to an audio conversion portion of the headphones 14 so as to be converted into audio. Thus, the audio is output.

FIG. 6 is a view showing the operation and effect of the rear entertainment system according to the invention. The fellow passenger in the rear seat is putting on the headphones 14 and sitting seeing forward. Audio signals modulated optically are transmitted from the front by the first IR transmission portion 12 and from the rear by the second IR transmission portion 13. In this state, the signals from the first IR transmission portion 12 are received optically by the photodiodes 43 and 44 of the headphones 14 disposed forward. On the other hand, the signals from the second IR transmission portion 13 are received optically by the photodiodes 45 and 46 disposed backward.

In this state, assume that disturbing light is incident in the direction referenced by the signs A to H. In this state, the travelling direction of the movable body such as a vehicle always varies so that the direction of sunlight varies at any time in accordance therewith. Thus, the incident direction of the disturbing light may vary frequently. Generally, the incident direction of sunlight is fixed in the domestic environment. Therefore, the sunlight can be blocked by a curtain or the like if it is obstructive. However, in a vehicle or the like having such a characteristic, it is difficult to deal with sunlight fully.

To solve such a problem, the photodiodes 43, 44, 45 and 46 are disposed in their positions and light receiving directions set as described above. For example, when disturbing light is incident from the front as shown by the sign A, the photodiodes 43 and 44 saturated therewith become useless. However, the photodiodes 45 and 46 can receive modulated light from the second IR transmission portion 13 normally. Since each photodiode is connected to a power supply through a reverse bias resistor individually, the signal received normally is supplied to the gate G of the FET 52 in spite of the saturated photodiodes.

When disturbing light is incident sideways as shown by the sign C, the photodiodes 43 and 45 saturated therewith become useless. However, the photodiode 44 can receive modulated light from the first IR transmission portion 12 normally and the photodiode 46 can receive modulated light from the second IR transmission portion 13 normally. Thus, the signal received normally is supplied to the gate G of the FET 52.

When disturbing light is incident obliquely as shown by the sign B, the photodiodes 43, 44 and 45 saturated therewith become useless. However, the photodiode 46 can receive modulated light from the second IR transmission portion 13 normally. Thus, the signal received normally is supplied to the gate G of the FET 52.

In the same manner, also when disturbing light is incident from any other direction D-H, at least one of the photodiodes is not saturated, so that light can be received normally. Incidentally, in the case where there is one intensive disturbing light source such as only the sunlight, there does not occur the case where all the photodiodes are saturated simultaneously when the photodiodes are arranged according to this embodiment. Accordingly, the headphones 14 as a whole can always receive and demodulate modulated light correctly.

FIG. 7 shows the state of the output of received light. The upper waveform designates the output of received light when there is no disturbing light, while the lower waveform designates the output of received light when disturbing light enters any one of the photodiodes. It is also proved from FIG. 7 that the output level is lowered by disturbing light in comparison with that in the case where there is no disturbing light, but signals can be separated sufficiently. Thus, the signals can be obtained in the state where the signals can be demodulated.

Here, for example, assume that in the optical reception portion, the cathode terminals 55 of the photodiodes 43, 44, 45 and 46 are connected in common to the power supply +V through a reverse bias resistor 83 as shown in FIG. 8. In this case, when any one of the photodiodes is saturated, the output of the saturated photodiode will fill the signal output with its saturated signal even if the other photodiodes are normal. That is, even if there is a photodiode receiving modulated light normally, the transmitted signal cannot be detected. The configuration of the optical reception portion according to the first embodiment solves this problem.

Incidentally, in FIG. 8, the reference numeral 81 represents a portion for receiving modulated light from the front. In the portion 81, the reference numeral 81a represents a part provided in the right ear portion of the headphones 14, and the reference numeral 81b represents a part provided in the left ear portion of the headphones 14. On the other hand, the reference numeral 82 represents a portion for receiving modulated light from the rear likewise. In the portion 82, the reference numeral 82a represents a part provided in the right ear portion of the headphones 14, and the reference numeral 82b represents a part provided in the left ear portion of the headphones 14. In addition, the configurations and operations of the inductor 51, the FET 52 and the resistor 53 are similar to those in the description of the first embodiment.

FIG. 9 shows the state of the output from the optical reception portion with the configuration of FIG. 8. The upper waveform designates the output of received light when there is no disturbing light, while the lower waveform designates the output of received light when disturbing light enters any one of the photodiodes. It is also proved from FIG. 9 that signals almost cannot be identified in the configuration of this optical reception portion.

As described above in detail, transmission units for radiating modulated light in accordance with audio signals are disposed in front of the rear seat and at the rear of the rear seat so as to radiate the modulated light backward and forward respectively. In addition, photodiodes for receiving the modulated light from the front and from the rear are disposed near the opposite ear portions of headphones respectively. Further, each of the photodiodes is connected to a power supply through a reverse bias resistor individually. Thus, if at least one of the photodiodes is not exposed to disturbing light, transmitted audio signals can be received and reproduced correctly.

(Second Embodiment)

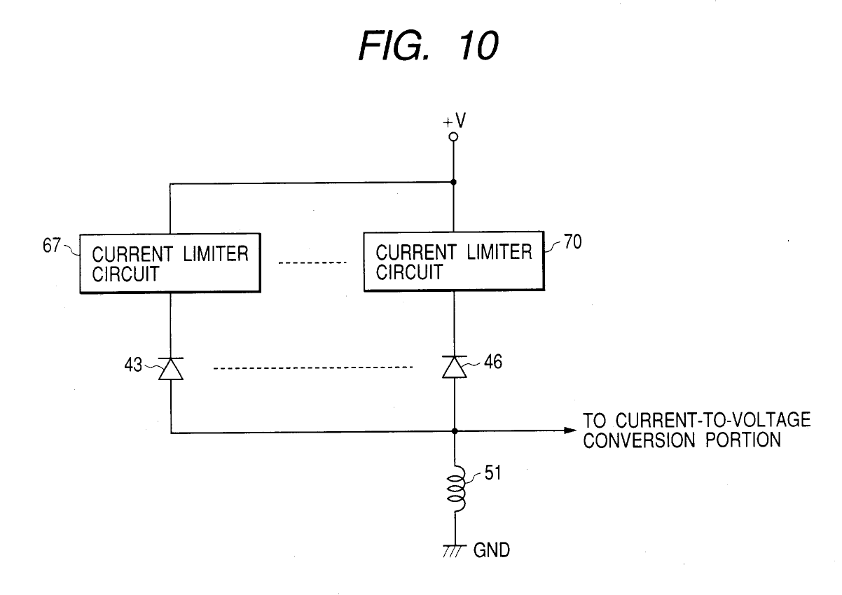

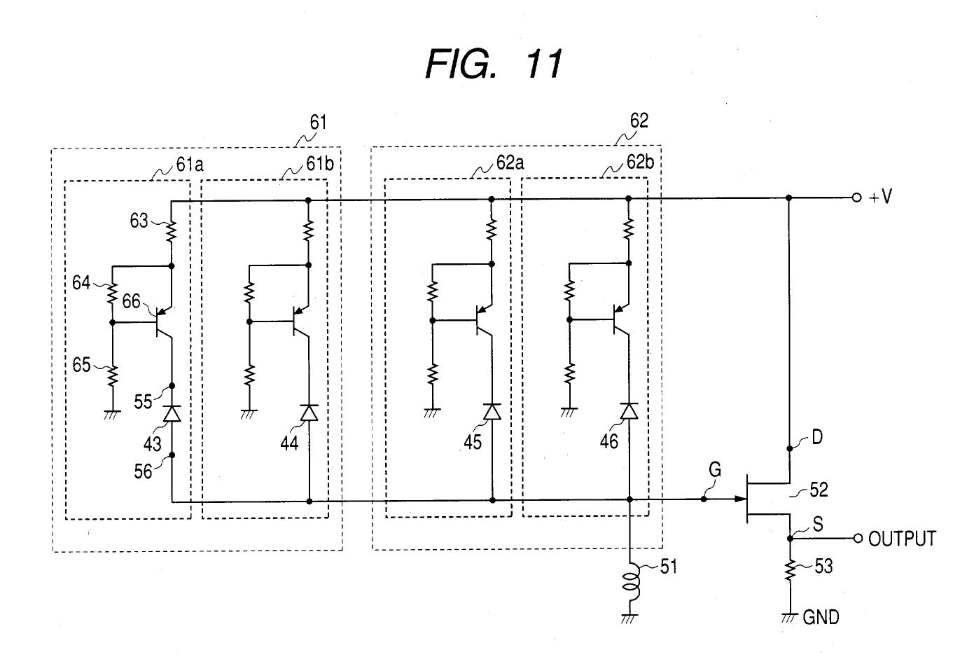

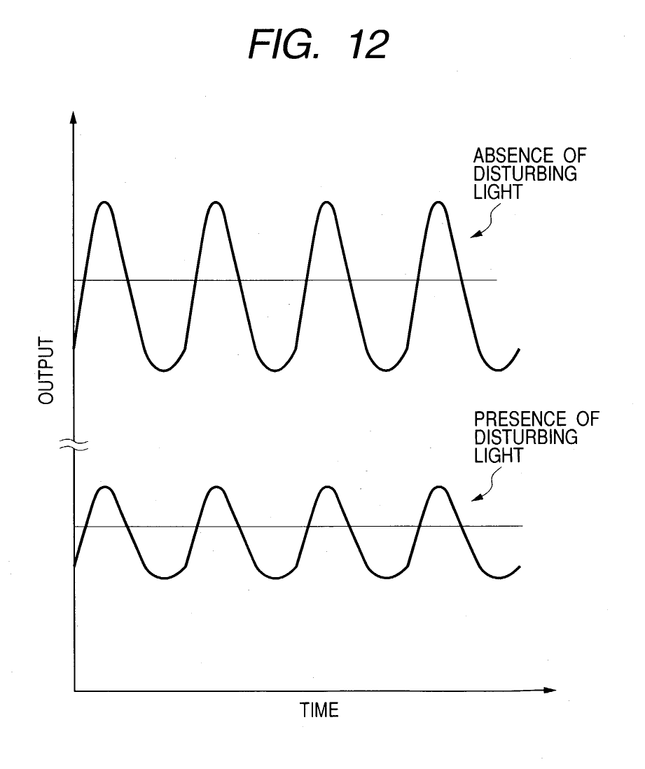

Next, the second embodiment will be described with reference to FIGS. 10 to 12. Incidentally, FIG. 10 shows the configuration of an optical reception portion of a rear entertainment system according to the second embodiment of the invention. FIG. 11 shows the circuit configuration of the optical reception portion according to the second embodiment. In addition, FIG. 12 is a graph showing the output of received light in accordance with the presence/absence of disturbing light in the second embodiment.

This embodiment differs from the first embodiment in the circuit configuration of its optical reception portion. Therefore, description will be made here on the circuit configuration of the optical reception portion. The description on technical items, which are same as those in the first embodiment, will be omitted while the description in the first embodiment will be referred to appropriately in accordance with necessity.

In the configuration of the optical reception portion according to this embodiment, as shown in FIG. 10, photodiodes 43 to 46 are connected to a power supply +V through current limiter circuits 67 to 70 respectively. The current limiter circuits 67 to 70 limit currents flowing into their corresponding photodiodes when disturbing light enters the photodiodes 43 to 46. Thus, the current limiter circuits 67 to 70 prevents a reception signal from being filled with the saturated output of the photodiode in which the disturbing light enters. Thus, a signal with quality high enough to be reproduced is detected. The output of the photodiodes is supplied to and demodulated in the circuit shown in FIG. 5 in the same manner as that in the first embodiment described previously.

FIG. 11 shows the circuit configuration of the optical reception portion. A cathode terminal 55 of the photodiode 43 is connected to the power supply +V through a PNP transistor and a resistor 63. A voltage generated by resistors 63, 64 and 65 is applied to the base of the transistor 66. The photodiodes 43, 44, 45 and 46 are connected in common and grounded through an inductor 51, while the output is supplied to the gate G of an FET 52 and output from the source S thereof.

In FIG. 11, the reference numeral 61 represents a portion for receiving modulated light from the front. In the portion 61, the reference numeral 61a represents a part provided in the right ear portion of the headphones 14, and the reference numeral 61b represents a part provided in the left ear portion of the headphones 14. On the other hand, the reference numeral 62 represents a portion for receiving modulated light from the rear likewise. In the portion 62, the reference numeral 62a represents a part provided in the right ear portion of the headphones 14, and the reference numeral 62b represents a part provided in the left ear portion of the headphones 14.

This circuit operates as follows. That is, for example, when disturbing light enters the photodiode 43 so that the photocurrent increases, the terminal-to-terminal voltage between the cathode terminal 55 and the anode terminal 56 drops down. Consequently, the base voltage of the transistor 66 drops down so that the voltage applied to the resistor 65 drops down. Thus, the current flowing into the resistor 65 is reduced. The transistor 66 wants to apply a current to the photodiode 43 in accordance with its base current, but the current is limited in accordance with the current applied to the resistor 65. Thus, the limit current can be determined by designing the value of the resistor 65.

FIG. 12 shows the state of the output. The upper waveform designates the output of received light when there is no disturbing light, while the lower waveform designates the output of received light when disturbing light enters any one of the photodiodes. It is proved from FIG. 12 that the output level is indeed lowered by disturbing light in comparison with that in the case where there is no disturbing light, but signals are reproduced in the state where the signals can be separated sufficiently. Thus, transmitted audio signals can be received and reproduced correctly if at least one of the photodiodes is not exposed to disturbing light.

Incidentally, the current limiter circuits are not limited to the circuit configuration. Any circuit configuration is applicable if it limits a current flowing into a photodiode in accordance with the quantity of light entering the photodiode.

(Third Embodiment)

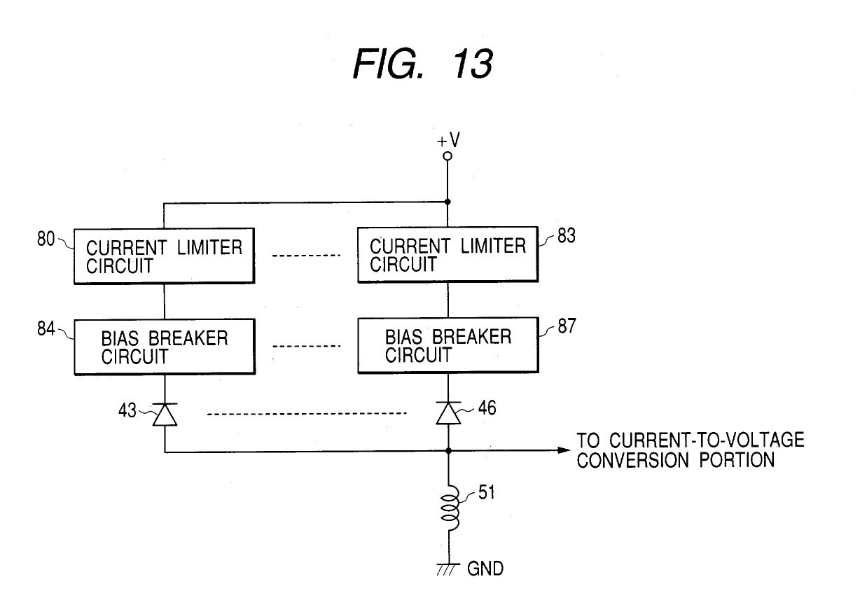

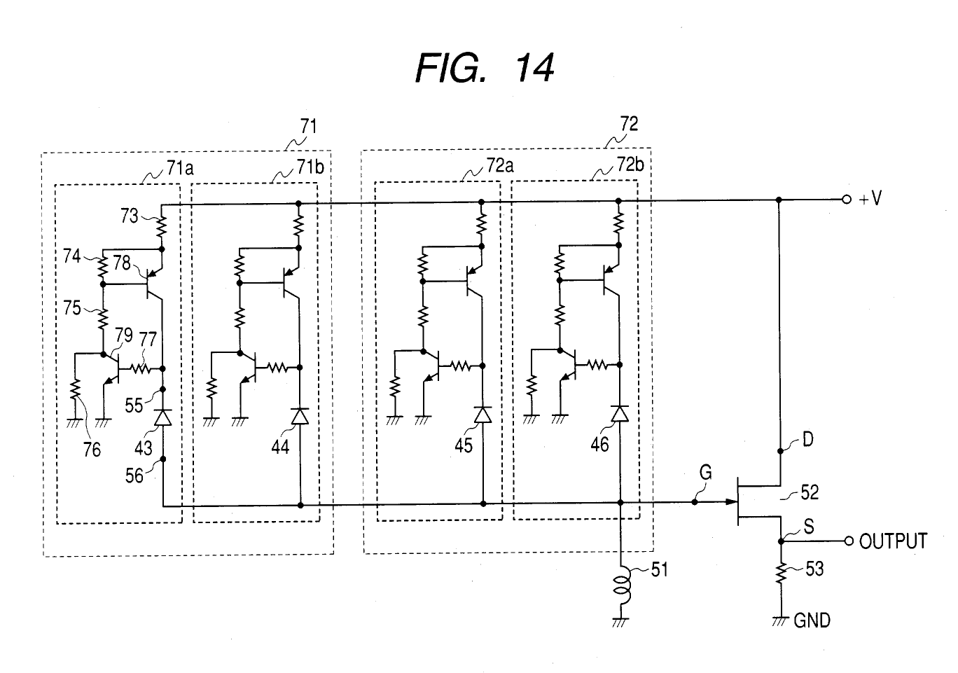

Next, the third embodiment will be described with reference to FIGS. 13 and 14. Incidentally, FIG. 13 shows the configuration of an optical reception portion of a rear entertainment system according to the third embodiment of the invention. FIG. 14 shows the circuit configuration of the optical reception portion according to the third embodiment.

This embodiment differs from the first embodiment in the circuit configuration of its optical reception portion. Therefore, description will be made here on the circuit configuration of the optical reception portion. The description on technical items, which are same as those in the first embodiment, will be omitted while the description in the first embodiment will be referred to appropriately in accordance with necessity.

In the configuration of the optical reception portion according to this embodiment, as shown in FIG. 13, photodiodes 43 to 46 are connected to a power supply +V through current limiter circuits 80 to 83 and bias breaker circuits 84 to 87 respectively. The current limiter circuits 80 to 83 limit currents flowing into their corresponding photodiodes when disturbing light enters the photodiodes 43 to 46. The bias breaker circuits 84 to 87 break currents flowing into the photodiodes when disturbing light having intensity not lower than predetermined one enters the photodiodes. Thus, a reception signal is prevented from being filled with the photodiode in which the disturbing light enters. Thus, a signal with quality high enough to be reproduced is detected. The output of the photodiodes is supplied to and demodulated in the circuit shown in FIG. 5 in the same manner as that in the first embodiment described previously.

FIG. 14 shows the circuit configuration of the optical reception portion. A cathode terminal 55 of the photodiode 43 is connected to the power supply +V through a PNP transistor 78 and a resistor 73. A voltage generated by resistors 73, 74, 75 and 76 is applied to the base of the transistor 78. In addition, an NPN transistor 79 is connected to the cathode terminal 55 through a resistor 77. The collector of the transistor 79 is grounded through a resistor 76 while the emitter is grounded directly. Here, a resistor having a larger resistance value than any other resistance value is used as the resistor 76. The photodiodes 43, 44, 45 and 46 are connected in common and grounded through an inductor 51, while the output is supplied to the gate G of an FET 52 and output from the source S thereof.

In FIG. 14, the reference numeral 71 represents a portion for receiving modulated light from the front. In the portion 71, the reference numeral 71a represents a part provided in the right ear portion of the headphones 14, and the reference numeral 71b represents a part provided in the left ear portion of the headphones 14. On the other hand, the reference numeral 72 represents a portion for receiving modulated light from the rear likewise. In the portion 72, the reference numeral 72a represents a part provided in the right ear portion of the headphones 14, and the reference numeral 72b represents a part provided in the left ear portion of the headphones 14.

This circuit operates as follows. That is, when disturbing light enters the photodiode 43 so that the photocurrent increases, the terminal-to-terminal voltage between the cathode terminal 55 and the anode terminal 56 drops down. Consequently, the transistor 79 is turned OFF. Thus, the transistor 78 wants to supply a power supply voltage +V and a current which is mainly determined by the resistors 75 and 76 to the base of the transistor 79 in order to turn the transistor 79 ON, but the resistor 76 has a large value. Thus, the current supplied to the base is so small that the transistor 79 cannot be turned ON. Thus, the current flowing into the photodiode 43 is blocked off.

When the disturbing light stops entering the photodiode 43, the terminal-to-terminal voltage between the cathode terminal 55 and the anode terminal 56 increases so that the transistor 79 is turned on and brought into its steady state. Accordingly, when disturbing light higher than a predetermined level enters the photodiode 43, the current flowing into the photodiode 43 is blocked off. Thus, the disturbing light has no influence on the output of any other photodiode. Further, for disturbing light not enough high to block off the current, the current limiter circuit 80 limits the current flowing into the photodiode 43 by the configuration and operation described in the second embodiment.

The output state is similar to that shown in FIG. 12. Even if there is disturbing light, an output of substantially the same level as that when there is no disturbing light can be obtained, so that excellent signal reproduction can be achieved. Thus, transmitted audio signals can be received and reproduced correctly if at least one of the photodiodes is not exposed to disturbing light.

Incidentally, the current limiter circuits are not limited to the above-described circuit configuration. Any circuit configuration is applicable if it blocks off a current flowing into a photodiode in accordance with the disturbing light higher than a predetermined level and entering the photodiode.

The invention is not limited to the embodiments. The invention can be modified appropriately without departing its spirit and idea that can be read from the accompanying claims and the specification as a whole. Any rear entertainment system modified thus is also included in the technical idea of the invention.

As has been described above, according to the rear entertainment system of the invention, even if intensive light such as sunlight is incident in any direction as disturbing light, there will be no fear that reception and demodulation of optical signals are interfered. Thus, audio signals can be listened to.

In addition, the audio signals can be listened to no matter where the fellow passenger in the rear seat moves in the vehicle interior or no matter how the fellow passenger turns his or her head.

What is claimed is:

1. An entertainment system mounted on a vehicle, the system comprising:
an audio signal transmitting unit; and
an audio signal receiving unit,
wherein the audio signal transmitting unit including:
a first transmitting unit for transmitting the supplied audio signals backward; and
a second transmitting unit for transmitting the supplied audio signals forward;
a signal supply unit for supplying same audio signals to the first and second transmitting units; and
wherein the audio signal receiving unit including:
a first receiving unit for receiving audio signals transmitted backward by at least one of the first and second transmitting units;
a second receiving unit for receiving audio signals transmitted forward by at least one of the first and second transmitting units; and
an audio signal converting unit capable of abutting against left and right ears and for converting the audio signals received by at least one of the first and second receiving units into sound based on mechanical vibration.

2. The entertainment system according to claim 1, wherein each of the first and second transmitting units has a unit for optically modulating the received audio signals and radiating the optically modulated audio signals.

3. The entertainment system according to claim 2, wherein light emitting devices used for the optical modulation are LEDs.

4. The entertainment system according to claim 2, wherein optical wavelength used for the optical modulation is in an infrared region.

5. The entertainment system according to claim 1, wherein the signal supply unit and the first transmitting unit are formed integrally with a rear monitor unit.

6. The entertainment system according to claim 2,
wherein the first receiving unit has light receiving devices for receiving the modulated light radiated backward, the light receiving devices located near left and right ears, respectively; and
the second receiving unit has light receiving devices for receiving the modulated light radiated forward, the light receiving devices located near left and right ears, respectively.

7. The entertainment system according to claim 6, wherein the light receiving devices are photodiodes.

8. The entertainment system according to claim 6, wherein the light receiving devices are phototransistors.

9. The entertainment system according to claim 7,
wherein each of cathode terminals of the photodiodes is connected to a power supply side through a reverse bias resistor individually; and
wherein anode terminals thereof are connected to an output transistor in common.

10. The entertainment system according to claim 7,
wherein each of cathode terminals of the photodiodes is connected to a power supply side through a current limiter unit individually; and
wherein anode terminals thereof are connected to an output transistor in common.

11. The entertainment system according to claim 7,
wherein each of cathode terminals of the photodiodes is connected to a power supply side through a current breaker unit individually; and
wherein anode terminals thereof are connected to an output transistor in common.

12. The entertainment system according to claim 7,
wherein each of cathode terminals of the photodiodes is connected to a power supply side through a current breaker unit and a current limiter unit in series individually; and
wherein anode terminals thereof are connected to an output transistor in common.

13. The entertainment system according to claim 9, wherein the anode terminals of the photodiodes connected in common are grounded through an inductor.

14. The entertainment system according to any one of claim 1, wherein the first and second receiving units and the audio signal converting unit constitute headphones.
